(19) United States
(12) Patent Application Publication
(10) Pub. No.: US 2025/0150873 A1
(43) Pub. Date: May 8, 2025

(54) REPORTING OF PREDICTED UE OVERHEATING

(71) Applicant: Telefonaktiebolaget LM Ericsson (publ), Stockholm (SE)

(72) Inventors: Pontus WALLENTIN, Linköping (SE); Lian ARAUJO, Solna (SE); Zhenhua ZOU, Solna (SE); Icaro Leonardo DA SILVA, Solna (SE)

(21) Appl. No.: 18/684,308

(22) PCT Filed: Aug. 4, 2022
(86) PCT No.: PCT/SE2022/050734

§ 371 Date: Feb. 16, 2024

Related U.S. Application Data
(60) Provisional application No. 63/235,434, filed on Aug. 20, 2021.

(51) Int. Cl. H04W 24/10; H04B 7/0413

(52) U.S. Cl. CPC H04W 24/10; H04B 7/0413

(57) ABSTRACT

A method of operating a UE in a wireless communications system includes generating a prediction regarding a condition relating to overheating of the UE, and reporting the prediction to a network node of the wireless communications system. A method of operating a network node in a wireless communication system includes receiving a report from a UE served by the network node of a prediction regarding a condition relating to overheating of the UE.

### BACKGROUND

The present application relates to wireless communication systems, and in particular to the operation of a user equipment (UE) in a wireless communication system.

### UE Assistance Information

In a wireless communication network, to optimize the user experience and to assist the network in configuring connected mode parameters and connection release handling, a UE may be configured to send assistance information to the network. In particular, the network may configure the UE to provide multiple types of information, such as an overheating indication and UE power saving preferences.

To report overheating in a 3GPP LTE or New Radio (BR) network, the UE includes the OverheatingAssistance information element (IE) in the UEAssistanceInformation message shown in FIG. 1. In the OverheatingAssistance IE, the UE can indicate a preference of actions to be taken by the network in order to reduce the overheating, such as reducing the number of carriers, reducing the bandwidth, reducing the number of MIMO layers used by the UE, etc. There is also a timer (T345) to limit how often the UE can provide the same type of indication. For overheating, this timer can be configured by the network using the overheatingIndicationProhibitTimer IE.

According to [1], one purpose of the UE assistance information reporting procedure is for the UE to inform the network of its overheating assistance information. A UE capable of providing overheating assistance information in RRC_CONNECTED mode may initiate the procedure if it was configured to do so, upon detecting internal overheating, or upon detecting that it is no longer experiencing an overheating condition.

### Machine Learning

Machine learning (ML) can be used to find a predictive function that relates features of a system to some property or output of a system for a given dataset. For example, machine learning may be used to classify or categorize some aspect of a system based on observed features of the system. The dataset is typically a mapping between a given input to an output. The predictive function (or mapping function) is generated in a training phase, where the training phase assumes knowledge of both the input and output. The test phase comprises predicting the output for a given input. Applications of machine learning are for example curve fitting, facial recognition and spam filter.

FIG. 2 shows an example of one type of machine learning, namely classification, where the task is to train a predictive function that separates two classes of objects (circle and cross class). Stated differently, the object of the example ML system of FIG. 2 is to determine whether a given object is a member of the cross class or the circle class based on examination of four features (Features 1-4) that can be observed relative to the object.

Referring to FIG. 2, graph (a) indicates that Features 1 and 2 provide low separation of the output class relative to each other, leading to a poor prediction performance in comparison with the graph (b) of FIG. 2, which uses Features 3 and 4 for prediction. That is, Features 3 and 4 provide a better separation and classifying performance relative to one another than do Features 1 and 2. In general, the performance of the machine learner is proportional to the correlation between the input and the output. One problem in machine learning is to find/create good features that provide a high degree of separation between classes. Another problem is to collect enough data samples to train the model accurately.

An example of classification in a radio context is the prediction of coverage on a frequency that is different from the serving frequency (here called secondary frequency) based on measurements on a serving frequency. In such an example, one could predict the reference signal received power (RSRP) of a secondary frequency based on the RSRP, timing advance (TA) and precoder index of cells on a serving frequency (including neighbor cells). The data could be collected through measurement reports or through specific combinations of events and inter-frequency measurement reports. Once trained, the ML model may be able to output an estimate of coverage for different frequencies, for new input data, which can be utilized in different ways such as in mobility to filter out relevant frequency candidates.

One such example is shown in FIG. 3, which illustrates a decision tree for predicting the coverage probability on another carrier given five different measurements on the source carrier. The measurement could represent an RSRP or RSRQ measurement of the serving or neighboring cell in an LTE context, or a RSRP/RSRQ beam measurement in NR context. The coverage probability is denoted by p, and no coverage is naturally defined as (1−p), Note that each leaf node will provide a different coverage probability p (p1-p8).

### SUMMARY

A method of operating a UE in a wireless communications system includes generating a prediction regarding a condition relating to overheating of the UE, and reporting the prediction to a network node of the wireless communications system.

The method may further include receiving a configuration from the network node for reporting the prediction regarding the condition relating to overheating, wherein the prediction regarding the condition relating to overheating may be generated according to the configuration.

The condition relating to overheating may include a predicted temperature of the UE and/or a predicted duration of the overheating condition.

The prediction regarding the condition relating to overheating may be generated using a machine learning model.

The prediction regarding the condition relating to overheating may be generated based on a plurality of features relating to wireless communications by the UE. The plurality of features include at least one of a bandwidth allocated to the UE, a number of configured multiple input multiple output, MIMO, layers of the UE, a number of carriers assigned to the UE, a throughput of communications with the UE, a buffer size in the UE, and sensor information collected by the UE.

The prediction regarding the condition relating to overheating may include a time window within which the prediction regarding the condition relating to overheating may be expected to occur.

The prediction regarding the condition relating to overheating may include a confidence level associated with the prediction. The confidence level may include a percentage likelihood of the condition relating to overheating occurring within a predetermined time period. The predetermined time period may be configured by the network node. The predetermined time period may be transmitted to the network node in a report that may include the prediction.

The prediction may only be reported to the network node if the confidence level may be greater than a threshold level.

The prediction regarding the condition relating to overheating may include a prediction of an onset of an overheating condition or a prediction of an end of an overheating condition.

The method may further include transmitting a recommended action for the network node to take to address the predicted condition relating to overheating. The recommended action may include at least one of reducing a bandwidth allocated to the UE, reducing a number of configured MIMO layers of the UE, reducing a number of carriers assigned to the UE, and reducing a throughput of communications with the UE.

The method may further include generating and transmitting to the network node an estimate of an amount of time overheating condition may be expected to continue after the recommended action may be taken.

The prediction regarding the condition relating to overheating may include a prediction of an end of an overheating condition, and wherein the prediction may be included in a report that also may include a report of the onset of the overheating condition.

The method may further include generating a prediction of an expected time when the overheating condition will require network intervention, and transmitting the prediction of the expected time when the overheating condition will require network intervention to the network node.

The method may further include determining the status of a prohibit timer before reporting the prediction to the network node, wherein the prediction may be only reported to the network node after the prohibit timer has expired.

The method may further include receiving a conditional configuration from the network node, and applying the conditional configuration in response to one of the following events: a predetermined overheating condition may be reached, a predicted overheating condition may be reported, and a predetermined time period has elapsed following the time that the predetermined overheating condition may be reached or that the predicted overheating condition was reported.

A method of operating a network node in a wireless communication system according to some embodiments includes receiving a report from a user equipment, UE, served by the network node of a prediction regarding a condition relating to overheating of the UE.

The method may further include configuring the UE to report the condition relating to overheating of the UE, wherein the prediction regarding a condition relating to overheating of the UE was generated by the UE in response to the configuring.

The method may further include forwarding the report to a second network node.

The method may further include reconfiguring the UE to address the condition relating to overheating of the UE.

The condition relating to overheating may include a predicted temperature of the UE and/or a predicted duration of the overheating condition.

The prediction regarding the condition relating to overheating may be generated using a machine learning model.

The prediction regarding the condition relating to overheating may be generated based on a plurality of features relating to wireless communications by the UE. The plurality of features include at least one of a bandwidth allocated to the UE, a number of configured multiple input multiple output, MIMO, layers of the UE, a number of carriers assigned to the UE, a throughput of communications with the UE, a buffer size in the UE, and sensor information collected by the UE.

The prediction regarding the condition relating to overheating may include a time window within which the prediction regarding the condition relating to overheating may be expected to occur.

The prediction regarding the condition relating to overheating may include a confidence level associated with the prediction.

The confidence level may include a percentage likelihood of the condition relating to overheating occurring within a predetermined time period. The predetermined time period may be configured by the network node. The predetermined time period may be received in the report.

The prediction regarding the condition relating to overheating may include a prediction of an onset of an overheating condition or a prediction of an end of an overheating condition.

The method may further include receiving from the UE a recommended action to take to address the predicted condition relating to overheating. The recommended action may include at least one of reducing a bandwidth allocated to the UE, reducing a number of configured MIMO layers of the UE, reducing a number of carriers assigned to the UE, and reducing a throughput of communications with the UE.

The method may further include receiving from the UE an estimate of an amount of time overheating condition may be expected to continue after the recommended action may be taken.

The prediction regarding the condition relating to overheating may include a prediction of an end of an overheating condition, and wherein the prediction may be included in the report.

The method may further include receiving from the UE a prediction of an expected time when the overheating condition will require network intervention to the network node.

The method may further include transmitting a conditional configuration to the UE, wherein the conditional configuration may be to be applied by the UE in response to one of the following events: a predetermined overheating condition may be reached, a predicted overheating condition may be reported, and a predetermined time period has elapsed following the time that the predetermined overheating condition may be reached or that the predicted overheating condition was reported.

### BRIEF DESCRIPTION OF THE DRAWINGS

FIG. 1 illustrates transmission of an OverheatingAssistance information element in a UEAssistanceInformation message.

FIG. 2 shows an example of classification machine learning.

FIG. 3 illustrates a decision tree for predicting the coverage probability on another carrier given different measurements on the source carrier.

FIG. 4 is a block diagram of a system structure according to some embodiments.

FIG. 5 illustrates operations performed by a UE according to some embodiments.

FIG. 6 illustrates operations performed by a network node according to some embodiments.

FIG. 7 schematically illustrates training of a machine learning, ML, model for generating predictions of an overheating condition.

FIG. 8 illustrates a deployment of a trained ML model in a UE.

FIG. 9 is a block diagram of a communication system in accordance with some embodiments.

FIG. 10 is a block diagram of a user equipment in accordance with some embodiments.

FIG. 11 is a block diagram of a network node in accordance with some embodiments.

FIG. 12 is a block diagram of a host computer communicating with a user equipment in accordance with some embodiments.

FIG. 13 is a block diagram of a virtualization environment in accordance with some embodiments.

FIG. 14 is a block diagram of a host computer communicating via a base station with a user equipment over a partially wireless connection in accordance with some embodiments in accordance with some embodiments.

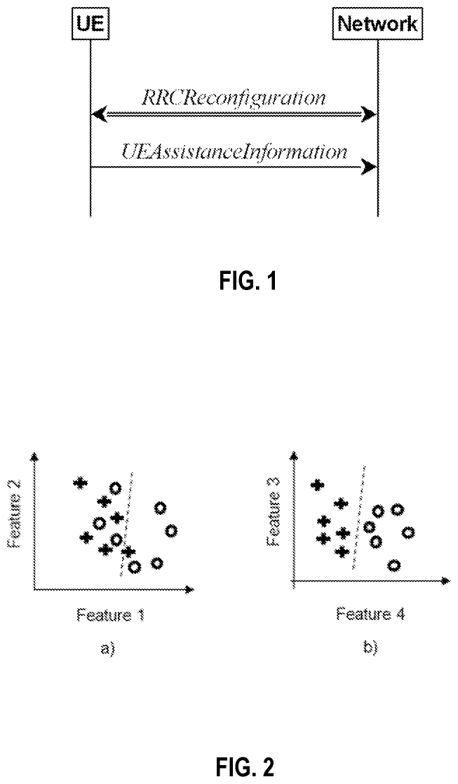

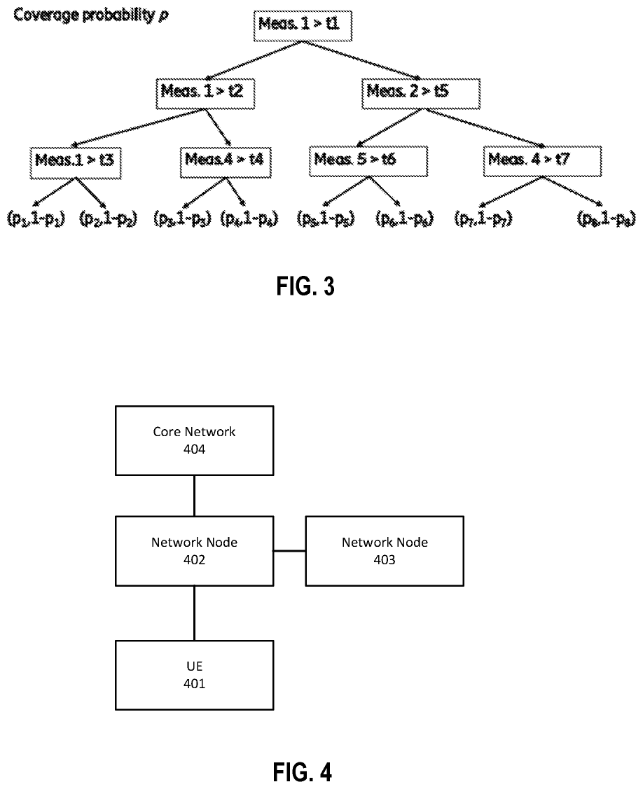

### DETAILED DESCRIPTION

There currently exist certain challenge(s) with respect to UE reporting of overheating conditions. With the UE Assistance Information procedure, a UE can indicate that an overheating condition in the UE has occurred. The network can then perform actions to address the overheating condition, such as a reconfiguration of the UE in an attempt to cause the UE to cool down.

A problem is that with the current framework for reporting overheating is that UE reports when it has already become overheated. Even if the overheating could have been predicted beforehand by the UE, it cannot report an overheating condition until the overheating condition has actually occurred. This in turn may cause any measures taken by the network triggered by receiving the report of overheating from the UE to be performed too late, which may result, for example, in a loss of connection with the UE caused by hardware malfunction or, in the worst, case a temporary or permanent UE hardware failure.

Certain aspects of the disclosure and their embodiments may provide solutions to these or other challenges. For example, some embodiments enable a UE to report a predicted overheating condition to a network node before the overheating condition actually occurs. The predicted overheating condition may be reported in radio resource control (RRC) message, such as in a UE Assistance Information message. According to some embodiments, the UE makes a prediction of a condition relating to overheating, and transmits a report the network containing the prediction of an overheating condition. The report may include a prediction of the duration of the overheating condition, the prediction of the temperature (e.g. in time units), a prediction of whether the overheating condition will persist indefinitely or is expected to end within a given duration. The UE may base the prediction on a radio configuration of the device, activity in another wireless component, traffic patterns, sensors and/or other available information. Radio conditions that can be used to predict an overheating condition may include, for example, a number of carriers with which the UE is configured, a bandwidth used by the UE, a number of MIMO layers used by the UE, etc.

In some embodiments, the UE also receives a configuration from a network node to configure the UE to report a predicted overheating condition, for example in an RRC message.

In some embodiments, the network may configure the UE to report a predicted overheating condition, for example in an RRC message.

Some embodiments may also enable the network to reconfigure the UE in response to a received report of a predicted overheating condition from the UE in order to address the overheating condition.

Certain embodiments may provide one or more of the following technical advantage(s). In particular, some embodiments enable a network to take measures to prevent the UE from overheating before an overheating condition occurs. This in turn may help to avoid a loss of connection with the UE caused by hardware malfunction or hardware failure. Some embodiments provide a proactive process in which the UE can be re-configured before it becomes overheated. This may help to avoid a situation following an overheating condition in which the network might not have the ability to reconfigure the UE to quickly reduce heating. In that case, the UE may remain in an overheated conditions for longer than suitable, which may degrade the hardware and/or the service experience.

Some embodiments provide a method performed by a UE to report a predicted overheating condition to a network node. According to some embodiments, the UE makes a prediction of a condition relating to an overheating condition that is expected to be experienced by the UE. The prediction may be generated using a machine learning (ML) model that is generated by or provided to the UE. The UE transmits a report of the predicted overheating to a network node. The report may be transmitted, for example, in an RRC message, such as a UEAssistanceInformation message.

In some embodiments, the condition relating to overheating includes one of: a predicted duration of the overheating condition, a prediction whether overheating will persist or is expected to resolve over time and/or a prediction of a temperature that is expected to be experienced by the UE.

In some embodiments, the report of a predicted overheating condition is based on a configuration received from a network node.

Some of the embodiments contemplated herein will now be described more fully with reference to the accompanying drawings. Embodiments are provided by way of example to convey the scope of the subject matter to those skilled in the art.

Some embodiments provide a method by a network node to handle a UE report of predicted overheating condition. The method includes configuring the UE to report predicted overheating condition and receiving a report from the UE that includes a prediction of an overheating condition that the UE expects to occur. In some embodiments, in response to the report from the UE, the network node sends a message/command to the UE to address the potential overheating condition before it occurs. The message/command may be sent in an RRC message, a medium access control (MAC) control element (CE), or in a different message. In some embodiments, the network node may forward the UE report to another node, such as a target node in connection with a handover or a neighbor node in connection with a secondary node addition or modification.

FIG. 4 is a block diagram of a system structure according to some embodiments. In the system illustrated in FIG. 4, a user equipment (UE) 401 is connected to a network node 402 over a radio interface, such as the 3GPP Uu radio interface for LTE or NR. The network node 402 is a base station, and in the case of 3GPP NR, is referred to as a gNodeB or gNB. The network node 402 is connected to a core network 404. The network node 402 is also connected to second network node 403. The interface between the network node 402 and the second network node 403 may be an internal interface within the radio access network, such as the Xn interface, but it may also be an interface between a radio access network and a core network. In the latter case, the network node 403 is part of the core network.

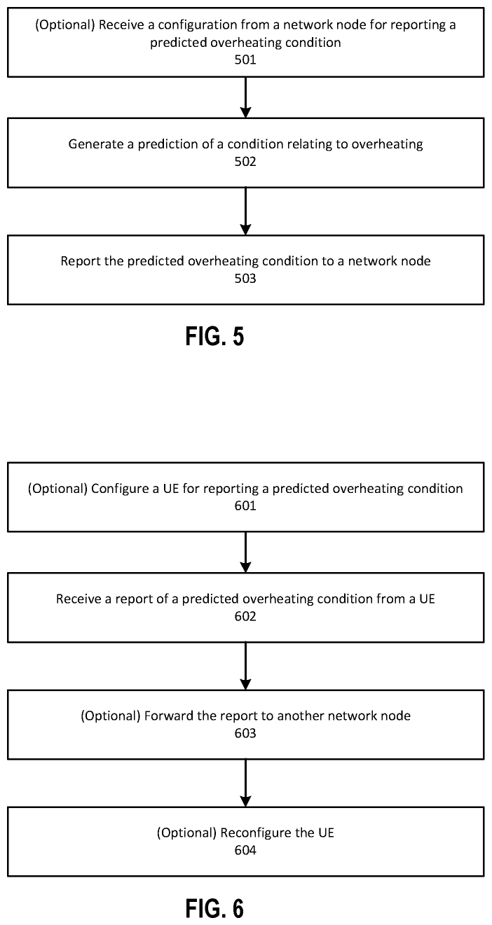

FIG. 5 illustrates some operations performed by the UE 401 according to some embodiments. At block 501, the UE optionally receives a configuration from a network node for reporting of predictions related to an overheating condition. The received configuration is stored in the UE. In some embodiments, the configuration to report overheating predictions may be combined with a configuration to report the occurrence of overheating conditions. For example, the UE may be configured to report both overheating conditions and predictions of overheating in the same UE assistance Information configuration.

At block 502, the UE generates a prediction of a condition relating to overheating. The prediction may be generated and/or based, for example, on information such as activity in a wireless component of the UE, traffic patterns, sensors and/or other available information which is used to anticipate a potential overheating condition. In one example, the predicted overheating condition is that the UE is about to become overheated. In another example, the predicted overheating condition is that the UE is about to recover from an overheated condition. Accordingly, depending on context, a “predicted overheating condition” or “overheating condition prediction” may include a condition of becoming overheated or a condition of recovering from being overheated.

In some embodiments, the UE may be configured by the network with a time window parameter that indicates how much time in advance the UE is to report a predicted overheating condition. For example, if the timer window is 10 seconds, the UE may report a predicted overheating condition that is expected to happen within 10 seconds.

To obtain the overheating condition prediction, the UE can generate and maintain its own machine learning model for overheating development over time based on its conditions such as wireless configuration, traffic requirements, etc.

At block 503, the UE reports the predicted overheating condition. The report may be contained in a message, such as an RRC message, transmitted to the network node. The RRC message may be, for example, a UE Assistance Information message.

If the UE has received a configuration for reporting predicted overheating conditions (in block 501), the UE may uses the configuration to determine what information should be included in the report.

In some embodiments, the report may indicate a time period in which the predicted overheating condition is expected to occur relative to the time the report is generated and/or sent. The report may further include an accuracy estimate, such as a confidence interval, associated with the prediction. For example, the report may include an indication that the overheating condition is expected to have an X % chance of occurring within a time period of Y seconds from the time of the report, where X and Y are generated as an output of one or more ML models used by the UE generate the prediction. For example, the UE may report that an overheating condition is expected with probability of 99% in 10 milliseconds, or with probability of 99.99% in 100 milliseconds, etc. The time period for which the prediction is made may be based on a configuration from the network. That is, the network may configure the UE to report a confidence interval for the prediction occurring within X milliseconds, where X is 10, 100, etc.

In some embodiments, the report may include a predicted duration of how long the UE configuration needs to be downgraded in order that overheating is ceased. In legacy approaches, after notifying the network of an overheating condition, the UE sends a notification to the network to indicate that overheating has ceased. In some embodiments, the UE may provide a duration prediction along with an overheating report. For example, the overheating report may indicate to the network that after X seconds following a downgrade of the UE configuration, the network may upgrade the UE configuration again e.g. increase number of SCells, the number of maximum MIMO layers, etc. This duration may also be reported per strategy or strategy combinations. For example, if the maximum number of MIMO layers is reduced, overheating ceases within X seconds, so after receiving that indication the network may reduce (by reconfiguring the UE) the maximum number of MIMO layers and after X seconds reconfigure the UE again to increase the number of MIMO layers. In some embodiments, the UE can autonomously change configuration (from downgraded to upgraded) after the indicated time elapses, subject to configuration by the network.

In further embodiments, the UE may indicate an expected time when the overheating condition may require network action. In this way, the network may still schedule the UE in further slots until it reaches the time indicated by the UE. Once this time is reached, the network may take other actions to address the UE overheating.

The information about predicted overheating may be included in the same report that includes an indication of an existing overheating condition. For example, the UE may be configured to report overheating conditions as previously performed and to include, in the same report, information regarding an overheating prediction, such as for how much time the overheating condition is expected to persist and/or when the overheating condition is expected to cease.

In some embodiments, the UE may indicates one or more suggested measures that may be performed by the network to avoid the upcoming overheating condition. For example, the UE may suggest one or more configuration changes that may be made by the network to potentially avoid the predicted overheating condition. Such configuration changes may include, for example, reducing a number of configured carriers of the UE, reducing a bandwidth of the UE, reducing a number of MIMO layers used by the UE, etc. For example, the UE could suggest that the network reduce a number of maximum secondary carriers or number of carriers assigned to the UE, reduce a maximum aggregated bandwidth (e.g. of frequency range 1 and/or frequency range 2), reduce a number of maximum MIMO layers of each serving cell operating on FR1, etc. A request for a reduced number of component carriers may be indicated separately for FR1 and FR2. Likewise a request for reduction in aggregated bandwidth and/or number of MIMO layers may be indicated separately for FR1 and FR2.

When a downgraded configuration is applied by the network in response to an overheating condition report, the UE may store the downgraded configuration for later use. For example, after reverting to a normal configuration, if a UE again predicts an overheating condition, the report may request that the network again apply the downgraded configuration. Alternately, the report may indicate that the UE will automatically apply the downgraded configuration, either when the report is transmitted or after a predetermined time period.

In some embodiments, the report may include a probability function of the UE overheating with respect to an interval of time in the future. For example, the probability that UE is expected to be in an overheating condition is a Poisson cumulative distribution function, which increases over time. This is to model the overheating condition due to the need to continuously serve the incoming traffic, which is typically a Poisson arrival. In another example, only the arrival rate is needed to be transmitted.

In some embodiments, the UE may be allowed to send its report only if a configured prohibited timer is not running. The prohibit timer may be stopped if an RRC reconfiguration from the network is received that would change the UE overheating condition or predictions of the UE overheating condition, including but not limiting to: a change the number of maximum secondary carriers/number of carriers, a reduction of the maximum aggregated bandwidth (e.g. of frequency range 1 and/or frequency range 2) FR1 and/or a reduction of the number of maximum MIMO layers of each serving cell operating on FR1.

In some embodiments, the UE may be allowed to send its report only if a configured “accuracy level” is achieved by the report the UE intends to send. For example, certain predictions may be better than others, and hence the UE may be configured to only report predictions above a certain threshold of accuracy. In some embodiments, the UE may be configured to report only if the confidence of the estimation is larger than a configurable threshold, such as 99%.

In some embodiments, the UE may be allowed to send its report only if a configured “accuracy level” has changed from “satisfied” to “non-satisfied” or from “non-satisfied” to “satisfied.”

In some embodiments, the UE may receive one or more conditional configurations from the network, that can be handled in multiple ways. For example, a conditional configuration may be applied once a certain overheating condition is achieved, or once a certain “accuracy level” of predicted overheating condition is reached. A conditional configuration may be applied upon reporting a predicted overheating and/or after a predetermined time period has passed after the overheating condition or prediction has been reported.

Once an overheating condition is no longer predicted, the UE may revert to a previous configuration and store such conditional configuration in case any overheating condition is triggered in the future.

The reporting configuration may contain multiple conditions, and/or may include multiple configurations to be applied or stored according to a certain conditions. In some embodiments, if the overheating condition has been detected by the UE, the UE provides to the network overheating assistance information including prediction trends related to overheating such as the current temperate and predicted temperature over time. In another example, the UE indicates a flag (e.g. ‘TRUE’) for at least an instance in time wherein the UE predicts that the temperature is going to be above a temperature threshold (possibly configured or specified).

In one embodiment, triggers for reporting predicted overheating conditions are predicted overheating conditions. For example, if the UE predicts that overheating is about to happen it triggers a report including predicted overheating conditions.

In one embodiment, triggers for reporting predicted overheating conditions are overheating conditions. For example, the UE triggers an overheating report as in legacy, when it experiences overheating conditions, and includes predicted overheating conditions e.g. how much is overheating supposed to continue and/or how is supposed to cease.

In one embodiment, triggers for reporting overheating conditions are both predicted overheating conditions and current overheating conditions. For example, UE only reports overheating conditions if the UE is overheated and if prediction of overheating conditions indicates that overheating is going to remain for longer than X seconds, wherein X is configured by the network or defined in specifications.

FIG. 6 illustrates operations performed by a network node 402, such as a gNB, according to some embodiments. Referring to FIG. 6, at block 601, the network node may optionally configure a UE for reporting an overheating condition. At block 602, the network node receives a report of a predicted overheating from the UE.

At block 603, the network node may optionally forward the received report to another network node, such as the second network node 403 shown in FIG. 4. The received report may, for example, be forwarded to the second network node 403 as part of a handover operation, a secondary node addition/reconfiguration, etc.

At block 604, in response to the received report, the network node may optionally take one or more remedial measures to address the predicted overheating condition. For example, the network node 402 may perform a reconfiguration of the UE 401 by sending an RRC message to it, such as an RRCReconfiguration message.

The network may decide to how to use a report of a predicted overheating condition based on the accuracy of the predicted overheating report is. For example, if the predicted overheating report is not too accurate, the UE may decide on apply the overheating detection of the usual overheating framework.

Likewise, the network may decide to how to use a report of a predicted overheating condition based on whether the UE previously sent a predicted UE reporting. The UE may override an overheating prediction report by sending a conventional overheating report. That implies that the UE is currently already in overheating situation (i.e. it is no longer a prediction but the current UE condition).

In some embodiments, the network may take remedial action to address the overheating condition once a certain overheating condition is achieved, or once a certain “accuracy level” of predicted overheating condition is reached. In some embodiments, the network may take action upon receipt of a report of a predicted overheating and/or according to time information related to overheating, e.g. after 10 seconds from the time the UE identified and reported a predicted overheating.

Accordingly, some embodiments provide a method performed by a network node to handle a UE report of a predicted overheating condition. The network node may configure the UE to report predicted overheating condition. The report may include a report of a prediction accuracy. That is, certain predictions may be better than others, and hence the UE may be configured to report predictions with different accuracy values. The report may include an expected duration for which the predicted overheating condition is valid or is expected to occur. In some embodiments, the report may include an expected time when the overheating condition may require network action. In this way, the network may still schedule the UE in further slots until it reaches the time indicated by the UE. Once this time is reached, the Network may take actions to address the UE overheating.

The report may include one or more suggested actions that could be taken by the network node to remediate or avoid the overheating conditions, such as reducing the number of component carriers of the UE, which may be indicated separately for FR1 and FR2, reducing an aggregated bandwidth allocated to the UE, which may be indicated separately for FR1 and FR2, and/or reducing a number of MIMO layers for the UE, which may be indicated separately for FR1 and FR2. The network node may configure the UE with a prohibited timer to avoid frequent UE reports.

In response to the overheating report, the network node may send an RRC message to the UE to reconfigure it and address overheating, or to reconfigure the UE after overheating condition is alleviated. The RRC message may, for example, activate/deactivate SCells based on the UE report, perform any of the other listed actions after a certain time, which may be based on the UE prediction on e.g. start of overheating.

Table 1 lists an example implementation in the RRC specification 3GPP TS 38.331, with changes underlined, for the case when the UE reports the prediction of overheating in the UE Assistance Information Message. In this example, the UE reports the prediction of overheating in a new field predictedOverheatingAssistance added to the UE Assistance Information message.

TABLE 1
Example UEAssistanceInformation IE

UEAssistanceInformation message
-- ASN1START
-- TAG-UEASSISTANCEINFORMATION-START

| | |
|---|---|
| UEAssistanceInformation ::= | SEQUENCE { |
| criticalExtensions | CHOICE { |
| ueAssistanceInformation | UEAssistanceInformation-IEs |
| criticalExtensionsFuture | SEQUENCE { } |

}
}

| UEAssistanceInformation-IEs ::= | SEQUENCE { | |
|---|---|---|
| delayBudgetReport | DelayBudgetReport | OPTIONAL, |
| lateNonCriticalExtension | OCTET STRING | OPTIONAL, |
| nonCriticalExtension | UEAssistanceInformation-v1540-IEs | OPTIONAL |

}

| | |
|---|---|
| DelayBudgetReport::= | CHOICE { |
| type1 | ENUMERATED { |
| | msMinus1280, msMinus640, msMinus320, msMinus160, msMinus80, msMinus60, msMinus40 |
| | msMinus20, ms0, ms20, ms40, ms60, ms80, ms160, ms320, ms640, minus1280} |

...
}

| UEAssistanceInformation-v1540-IEs ::= | SEQUENCE { | |
|---|---|---|
| overheatingAssistance | OverheatingAssistance | OPTIONAL, |
| nonCriticalExtension | UEAssistanceInformation-v1610-IEs | OPTIONAL |

}

| OverheatingAssistance ::= | SEQUENCE { | |
|---|---|---|
| reducedMaxCCs | ReducedMaxCCs-r16 | OPTIONAL, |
| reducedMaxBW-FR1 | ReducedMaxBW-FRx-r16 | OPTIONAL, |
| reducedMaxBW-FR2 | ReducedMaxBW-FRx-r16 | OPTIONAL, |

| | |
|---|---|
| reducedMaxMIMO-LayersFR1 | SEQUENCE { |
| reducedMIMO-LayersFR1-DL | MIMO-LayersDL, |
| reducedMIMO-LayersFR1-UL | MIMO-LayersUL |

} OPTIONAL,

| | |
|---|---|
| reducedMaxMIMO-LayersFR2 | SEQUENCE { |
| reducedMIMO-LayersFR2-DL | MIMO-LayersDL, |
| reducedMIMO-LayersFR2-UL | MIMO-LayersUL |

} OPTIONAL
}

| | |
|---|---|
| ReducedAggregatedBandwidth ::= | ENUMERATED {mhz0, mhz10, mhz20, mhz30, mhz40, mhz50, mhz60, mhz80, mhz100, |

mhz200, mhz300, mhz400}

| UEAssistanceInformation-v1610-IEs ::= | SEQUENCE { | |
|---|---|---|
| idc-Assistance-r16 | IDC-Assistance-r16 | OPTIONAL, |
| drx-Preference-r16 | DRX-Preference-r16 | OPTIONAL, |
| maxBW-Preference-r16 | MaxBW-Preference-r16 | OPTIONAL, |
| maxCC-Preference-r16 | MaxCC-Preference-r16 | OPTIONAL, |
| maxMIMO-LayerPreference-r16 | maxMIMO-LayerPreference-r16 | OPTIONAL, |
| minSchedulingOffsetPreference-r16 | MinSchedulingOffsetPreference-r16 | OPTIONAL, |
| releasePreference-r16 | ReleasePreference-r16 | OPTIONAL, |
| sl-UE-AssistanceInformationNR-r16 | SL-UE-AssistanceInformationNR-r16 | OPTIONAL, |
| referenceTimeInfoPreference-r16 | BOOLEAN | OPTIONAL, |
| nonCriticalExtension | UEAssistanceInformation-v1800-IEs | OPTIONAL |

}

| UEAssistanceInformation-v1800-IEs ::= | SEQUENCE { | |
|---|---|---|
| predictedOverheatingAssistance | PredictedOverheatingAssistance | OPTIONAL, |
| nonCriticalExtension | SEQUENCE { } | OPTIONAL |

}

| PredictedOverheatingAssistance ::= | SEQUENCE { | |
|---|---|---|
| reducedMaxCCs | ReducedMaxCCs-r16 | OPTIONAL, |
| reducedMaxBW-FR1 | ReducedMaxBW-FRx-r16 | OPTIONAL, |
| reducedMaxBW-FR2 | ReducedMaxBW-FRx-r16 | OPTIONAL, |

| | |
|---|---|
| reducedMaxMIMO-LayersFR1 | SEQUENCE { |
| reducedMIMO-LayersFR1-DL | MIMO-LayersDL, |
| reducedMIMO-LayersFR1-UL | MIMO-LayersUL |

} OPTIONAL,

| | |
|---|---|
| reducedMaxMIMO-LayersFR2 | SEQUENCE { |
| reducedMIMO-LayersFR2-DL | MIMO-LayersDL, |
| reducedMIMO-LayersFR2-UL | MIMO-LayersUL |

} OPTIONAL,

| | |
|---|---|
| overheatingDuration | ENUMERATED { |
| | ms10, ms20, ms30, ms40, ms50, ms60, ms80, ms100, ms200, ms300, ms500, ms750, ms1280, ms1920, |

ms2560, spare9, spare8, spare7, spare6, spare5, spare4, spare3, spare2, spare1} OPTIONAL,

| | |
|---|---|
| overheatingStartTime | ENUMERATED { |
| | ms10, ms20, ms30, ms40, ms50, ms60, ms80, ms100, ms200, ms300, ms500, ms750, ms1280, ms1920, |

ms2560, spare9, spare8, spare7, spare6, spare5, spare4, spare3, spare2, spare1} OPTIONAL
}
-- TAG-UEASSISTANCEINFORMATION-STOP
reducedBW-FR1
Indicates the UE's preference on reduced configuration corresponding to the maximum aggregated bandwidth
across all downlink carrier(s) and across all uplink carrier(s) of FR1, to address overheating or power saving. This
field is allowed to be reported only when UE is configured with serving cell(s) operating on FR1. The aggregated
bandwidth across all downlink carrier(s) of FR1 is the sum of bandwidth of active downlink BWP(s) across all
activated downlink carrier(s) of FR1. The aggregated bandwidth across all uplink carrier(s) of FR1 is the sum of
bandwidth of active uplink BWP(s) across all activated uplink carrier(s) of FR1. If the field is absent from the
MaxBW-Preference IE or the OverheatingAssistance IE, it is interpreted as the UE having no preference on the
maximum aggregated bandwidth of FR1.
When indicated to address overheating or a predicted overheating, this maximum aggregated bandwidth includes
carrier(s) of FR1 of both the NR MCG and the SCG. This maximum aggregated bandwidth only includes carriers
of FR1 of the SCG in (NG)EN-DC. Value mhz0 is not used when indicated to address overheating.
When indicated to address power saving, this maximum aggregated bandwidth includes carrier(s) of FR1 of the
cell group that this UE assistance information is associated with. The aggregated bandwidth can only range up to
the current active configuration when indicated to address power savings.
reducedBW-FR2
Indicates the UE's preference on reduced configuration corresponding to the maximum aggregated bandwidth
across all downlink carrier(s) and across all uplink carrier(s) of FR2, to address overheating or power saving. This
field is allowed to be reported only when UE is configured with serving cell(s) operating on FR2. The aggregated
bandwidth across all downlink carrier(s) of FR2 is the sum of bandwidth of active downlink BWP(s) across all
activated downlink carrier(s) of FR2. The aggregated bandwidth across all uplink carrier(s) of FR2 is the sum of
bandwidth of active uplink BWP(s) across all activated uplink carrier(s) of FR2. If the field is absent from the
MaxBW-Preference IE or the OverheatingAssistance IE, it is interpreted as the UE having no preference on the
maximum aggregated bandwidth of FR2.
When indicated to address overheating or a predicted overheating, this maximum aggregated bandwidth includes
carrier(s) of FR2 of both the NR MCG and the NR SCG. This maximum aggregated bandwidth only includes
carriers of FR2 of the SCG in (NG)EN-DC.
When indicated to address power saving, this maximum aggregated bandwidth includes carrier(s) of FR2 of the
cell group that this UE assistance information is associated with. The aggregated bandwidth can only range up to
the current active configuration when indicated to address power savings.
reducedCCsDL
Indicates the UE's preference on reduced configuration corresponding to the maximum number of downlink SCells
indicated by the field, to address overheating or power saving.
When indicated to address overheating or a predicted overheating, this maximum number includes both SCells of
the NR MCG and PSCell/SCells of the SCG. This maximum number only includes PSCell/SCells of the SCG in
(NG)EN-DC.
When indicated to address power saving, this maximum number includes PSCell/SCells of the cell group that this
UE assistance information is associated with. The maximum number of downlink SCells can only range up to the
current active configuration when indicated to address power savings.
reducedCCsUL
Indicates the UE's preference on reduced configuration corresponding to the maximum number of uplink SCells
indicated by the field, to address overheating or power saving.
When indicated to address overheating or a predicted overheating, this maximum number includes both SCells of
the NR MCG and PSCell/SCells of the SCG. This maximum number only includes PSCell/SCells of the SCG in
(NG)EN-DC.
When indicated to address power saving, this maximum number includes PSCell/SCells of the cell group that this
UE assistance information is associated with. The maximum number of uplink SCells can only range up to the
current active configuration when indicated to address power savings.
reducedMIMO-LayersFR1-DL
Indicates the UE's preference on reduced configuration corresponding to the maximum number of downlink MIMO
layers of each serving cell operating on FR1 indicated by the field, to address overheating or a predicted
overheating or power saving. This field is allowed to be reported only when UE is configured with serving cells
operating on FR1. The maximum number of downlink MIMO layers can only range up to the maximum number of
MIMO layers configured across all activated downlink carrier(s) of FR1 in the cell group when indicated to address
power savings.
reducedMIMO-LayersFR1-UL
Indicates the UE's preference on reduced configuration corresponding to the maximum number of uplink MIMO
layers of each serving cell operating on FR1 indicated by the field, to address overheating or a predicted
overheating or power saving. This field is allowed to be reported only when UE is configured with serving cells
operating on FR1. The maximum number of uplink MIMO layers can only range up to the maximum number of
MIMO layers configured across all activated uplink carrier(s) of FR1 in the cell group when indicated to address
power savings.
reducedMIMO-LayersFR2-DL
Indicates the UE's preference on reduced configuration corresponding to the maximum number of downlink MIMO
layers of each serving cell operating on FR2 indicated by the field, to address overheating or a predicted
overheating or power saving. This field is allowed to be reported only when UE is configured with serving cells
operating on FR2. The maximum number of downlink MIMO layers can only range up to the maximum number of
MIMO layers configured across all activated downlink carrier(s) of FR2 in the cell group when indicated to address
power savings.
reducedMIMO-LayersFR2-UL
Indicates the UE's preference on reduced configuration corresponding to the maximum number of uplink MIMO
layers of each serving cell operating on FR2 indicated by the field, to address overheating or a predicted
overheating or power saving. This field is allowed to be reported only when UE is configured with serving cells
operating on FR2. The maximum number of uplink MIMO layers can only range up to the maximum number of
MIMO layers configured across all activated uplink carrier(s) of FR2 in the cell group when indicated to address
power savings.

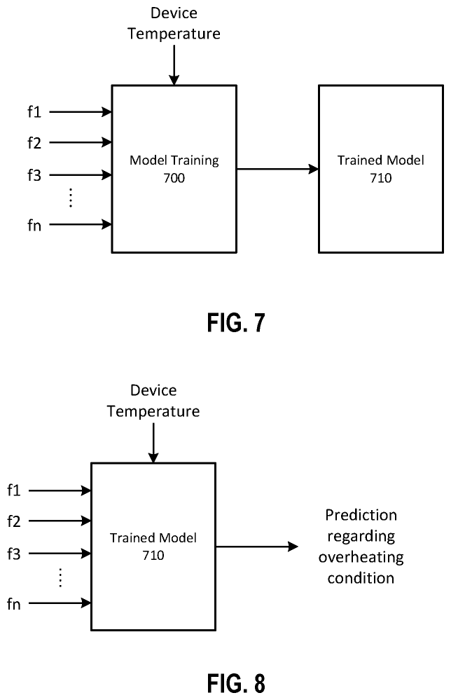

FIG. 7 schematically illustrates training of a machine learning, ML, model for generating predictions of an overheating condition. An ML model can be trained by the UE or can be trained by another node and provided to the UE. As shown in FIG. 7, in a training phase, a model training unit receives one or more features f1-fn that can affect the heating characteristics of a UE. Such features may be provided as time series data and may include such factors as bandwidth, number of configured MIMO layers, number of carriers, throughput, buffer size and other factors relating to the communication load and/or activity of the UE that can contribute to overheating in the device. The model training unit also receives device temperature data, such as processor temperature reported by one or more processors in the UE. The model training unit 700 uses the temperature data as training data for training the ML model to predict when overheating may occur based on the input features. The model training unit 700 generates a trained ML model using conventional ML training techniques. For example, if the ML model includes a neural network, the network may be trained using well-known backpropagation techniques.

Referring to FIG. 8, once the ML model 710 has been trained, it is deployed in the UE and may be used to generate predictions regarding overheating conditions as described above based on feature data f1-fn observed or collected during device operation. That is, as the UE operates, it collects information relating to the features f1-fn and provides the collected information as inputs to the trained ML model 710. The ML model 710 generates predictions with associated confidence scores based on the inputs.

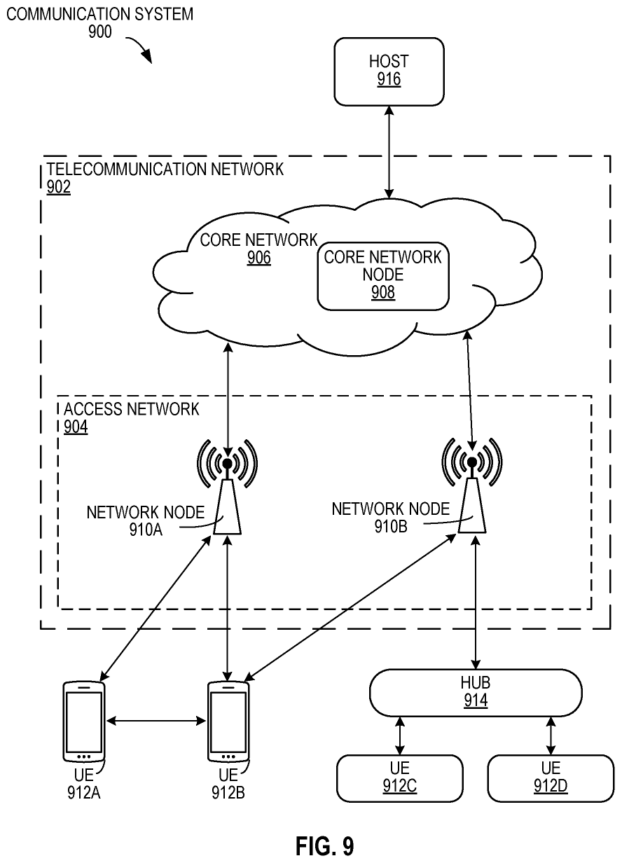

FIG. 9 shows an example of a communication system 900 in accordance with some embodiments.

In the example, the communication system 900 includes a telecommunication network 902 that includes an access network 904, such as a radio access network (RAN), and a core network 906, which includes one or more core network nodes 908. The access network 904 includes one or more access network nodes, such as network nodes 910a and 910b (one or more of which may be generally referred to as network nodes 910), or any other similar 3rd Generation Partnership Project (3GPP) access node or non-3GPP access point. The network nodes 910 facilitate direct or indirect connection of user equipment (UE), such as by connecting UEs 912a, 912b, 912c, and 912d (one or more of which may be generally referred to as UEs 912) to the core network 906 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 900 may include any number of wired or wireless networks, network nodes, UEs, and/or any other components or systems that may facilitate or participate in the communication of data and/or signals whether via wired or wireless connections. The communication system 900 may include and/or interface with any type of communication, telecommunication, data, cellular, radio network, and/or other similar type of system.

The UEs 912 may be any of a wide variety of communication devices, including wireless devices arranged, configured, and/or operable to communicate wirelessly with the network nodes 910 and other communication devices. Similarly, the network nodes 910 are arranged, capable, configured, and/or operable to communicate directly or indirectly with the UEs 912 and/or with other network nodes or equipment in the telecommunication network 902 to enable and/or provide network access, such as wireless network access, and/or to perform other functions, such as administration in the telecommunication network 902.

In the depicted example, the core network 906 connects the network nodes 910 to one or more hosts, such as host 916. These connections may be direct or indirect via one or more intermediary networks or devices. In other examples, network nodes may be directly coupled to hosts. The core network 906 includes one more core network nodes (e.g., core network node 908) that are structured with hardware and software components. Features of these components may be substantially similar to those described with respect to the UEs, network nodes, and/or hosts, such that the descriptions thereof are generally applicable to the corresponding components of the core network node 908. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 916 may be under the ownership or control of a service provider other than an operator or provider of the access network 904 and/or the telecommunication network 902, and may be operated by the service provider or on behalf of the service provider. The host 916 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 900 of FIG. 9 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 902 is a cellular network that implements 3GPP standardized features. Accordingly, the telecommunications network 902 may support network slicing to provide different logical networks to different devices that are connected to the telecommunication network 902. For example, the telecommunications network 902 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 912 are configured to transmit and/or receive information without direct human interaction. For instance, a UE may be designed to transmit information to the access network 904 on a predetermined schedule, when triggered by an internal or external event, or in response to requests from the access network 904. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 914 communicates with the access network 904 to facilitate indirect communication between one or more UEs (e.g., UE 912c and/or 912d) and network nodes (e.g., network node 910b). In some examples, the hub 914 may be a controller, router, content source and analytics, or any of the other communication devices described herein regarding UEs. For example, the hub 914 may be a broadband router enabling access to the core network 906 for the UEs. As another example, the hub 914 may be a controller that sends commands or instructions to one or more actuators in the UEs. Commands or instructions may be received from the UEs, network nodes 910, or by executable code, script, process, or other instructions in the hub 914. As another example, the hub 914 may be a data collector that acts as temporary storage for UE data and, in some embodiments, may perform analysis or other processing of the data. As another example, the hub 914 may be a content source. For example, for a UE that is a VR headset, display, loudspeaker or other media delivery device, the hub 914 may retrieve VR assets, video, audio, or other media or data related to sensory information via a network node, which the hub 914 then provides to the UE either directly, after performing local processing, and/or after adding additional local content. In still another example, the hub 914 acts as a proxy server or orchestrator for the UEs, in particular in if one or more of the UEs are low energy IoT devices.

The hub 914 may have a constant/persistent or intermittent connection to the network node 910b. The hub 914 may also allow for a different communication scheme and/or schedule between the hub 914 and UEs (e.g., UE 912c and/or 912d), and between the hub 914 and the core network 906. In other examples, the hub 914 is connected to the core network 906 and/or one or more UEs via a wired connection. Moreover, the hub 914 may be configured to connect to an M2M service provider over the access network 904 and/or to another UE over a direct connection. In some scenarios, UEs may establish a wireless connection with the network nodes 910 while still connected via the hub 914 via a wired or wireless connection. In some embodiments, the hub 914 may be a dedicated hub—that is, a hub whose primary function is to route communications to/from the UEs from/to the network node 910b. In other embodiments, the hub 914 may be a non-dedicated hub—that is, a device which is capable of operating to route communications between the UEs and network node 910b, but which is additionally capable of operating as a communication start and/or end point for certain data channels.

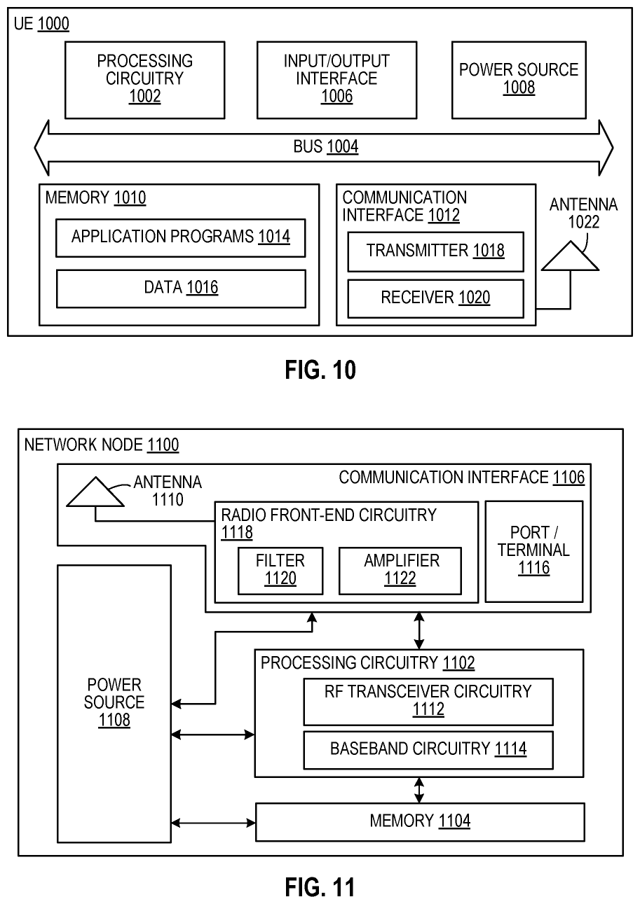

FIG. 10 shows a UE 1000 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 1000 includes processing circuitry 1002 that is operatively coupled via a bus 1004 to an input/output interface 1006, a power source 1008, a memory 1010, a communication interface 1012, and/or any other component, or any combination thereof. Certain UEs may utilize all or a subset of the components shown in FIG. 10. The level of integration between the components may vary from one UE to another UE. Further, certain UEs may contain multiple instances of a component, such as multiple processors, memories, transceivers, transmitters, receivers, etc.

The processing circuitry 1002 is configured to process instructions and data and may be configured to implement any sequential state machine operative to execute instructions stored as machine-readable computer programs in the memory 1010. The processing circuitry 1002 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 1002 may include multiple central processing units (CPUs).

In the example, the input/output interface 1006 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1000. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 1008 is structured as a battery or battery pack. Other types of power sources, such as an external power source (e.g., an electricity outlet), photovoltaic device, or power cell, may be used. The power source 1008 may further include power circuitry for delivering power from the power source 1008 itself, and/or an external power source, to the various parts of the UE 1000 via input circuitry or an interface such as an electrical power cable. Delivering power may be, for example, for charging of the power source 1008. Power circuitry may perform any formatting, converting, or other modification to the power from the power source 1008 to make the power suitable for the respective components of the UE 1000 to which power is supplied.

The memory 1010 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 1010 includes one or more application programs 1014, such as an operating system, web browser application, a widget, gadget engine, or other application, and corresponding data 1016. The memory 1010 may store, for use by the UE 1000, any of a variety of various operating systems or combinations of operating systems.

The memory 1010 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 1010 may allow the UE 1000 to access instructions, application programs and the like, stored on transitory or non-transitory memory media, to off-load data, or to upload data. An article of manufacture, such as one utilizing a communication system may be tangibly embodied as or in the memory 1010, which may be or comprise a device-readable storage medium.

The processing circuitry 1002 may be configured to communicate with an access network or other network using the communication interface 1012. The communication interface 1012 may comprise one or more communication subsystems and may include or be communicatively coupled to an antenna 1022. The communication interface 1012 may include one or more transceivers used to communicate, such as by communicating with one or more remote transceivers of another device capable of wireless communication (e.g., another UE or a network node in an access network). Each transceiver may include a transmitter 1018 and/or a receiver 1020 appropriate to provide network communications (e.g., optical, electrical, frequency allocations, and so forth). Moreover, the transmitter 1018 and receiver 1020 may be coupled to one or more antennas (e.g., antenna 1022) and may share circuit components, software or firmware, or alternatively be implemented separately.

In the illustrated embodiment, communication functions of the communication interface 1012 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1012, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 1000 shown in FIG. 10.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 11 shows a network node 1100 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1100 includes a processing circuitry 1102, a memory 1104, a communication interface 1106, and a power source 1108. The network node 1100 may be composed of multiple physically separate components (e.g., a NodeB component and a RNC component, or a BTS component and a BSC component, etc.), which may each have their own respective components. In certain scenarios in which the network node 1100 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 1100 may be configured to support multiple radio access technologies (RATs). In such embodiments, some components may be duplicated (e.g., separate memory 1104 for different RATs) and some components may be reused (e.g., a same antenna 1110 may be shared by different RATs). The network node 1100 may also include multiple sets of the various illustrated components for different wireless technologies integrated into network node 1100, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1100.

The processing circuitry 1102 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1100 components, such as the memory 1104, to provide network node 1100 functionality.

In some embodiments, the processing circuitry 1102 includes a system on a chip (SOC). In some embodiments, the processing circuitry 1102 includes one or more of radio frequency (RF) transceiver circuitry 1112 and baseband processing circuitry 1114. In some embodiments, the radio frequency (RF) transceiver circuitry 1112 and the baseband processing circuitry 1114 may be on separate chips (or sets of chips), boards, or units, such as radio units and digital units. In alternative embodiments, part or all of RF transceiver circuitry 1112 and baseband processing circuitry 1114 may be on the same chip or set of chips, boards, or units.

The memory 1104 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1102. The memory 1104 may store any suitable instructions, data, or information, including a computer program, software, an application including one or more of logic, rules, code, tables, and/or other instructions capable of being executed by the processing circuitry 1102 and utilized by the network node 1100. The memory 1104 may be used to store any calculations made by the processing circuitry 1102 and/or any data received via the communication interface 1106. In some embodiments, the processing circuitry 1102 and memory 1104 is integrated.

The communication interface 1106 is used in wired or wireless communication of signaling and/or data between a network node, access network, and/or UE. As illustrated, the communication interface 1106 comprises port(s)/terminal(s) 1116 to send and receive data, for example to and from a network over a wired connection. The communication interface 1106 also includes radio front-end circuitry 1118 that may be coupled to, or in certain embodiments a part of, the antenna 1110. Radio front-end circuitry 1118 comprises filters 1120 and amplifiers 1122. The radio front-end circuitry 1118 may be connected to an antenna 1110 and processing circuitry 1102. The radio front-end circuitry may be configured to condition signals communicated between antenna 1110 and processing circuitry 1102. The radio front-end circuitry 1118 may receive digital data that is to be sent out to other network nodes or UEs via a wireless connection. The radio front-end circuitry 1118 may convert the digital data into a radio signal having the appropriate channel and bandwidth parameters using a combination of filters 1120 and/or amplifiers 1122. The radio signal may then be transmitted via the antenna 1110. Similarly, when receiving data, the antenna 1110 may collect radio signals which are then converted into digital data by the radio front-end circuitry 1118. The digital data may be passed to the processing circuitry 1102. In other embodiments, the communication interface may comprise different components and/or different combinations of components.

In certain alternative embodiments, the network node 1100 does not include separate radio front-end circuitry 1118, instead, the processing circuitry 1102 includes radio front-end circuitry and is connected to the antenna 1110. Similarly, in some embodiments, all or some of the RF transceiver circuitry 1112 is part of the communication interface 1106. In still other embodiments, the communication interface 1106 includes one or more ports or terminals 1116, the radio front-end circuitry 1118, and the RF transceiver circuitry 1112, as part of a radio unit (not shown), and the communication interface 1106 communicates with the baseband processing circuitry 1114, which is part of a digital unit (not shown).

The antenna 1110 may include one or more antennas, or antenna arrays, configured to send and/or receive wireless signals. The antenna 1110 may be coupled to the radio front-end circuitry 1118 and may be any type of antenna capable of transmitting and receiving data and/or signals wirelessly. In certain embodiments, the antenna 1110 is separate from the network node 1100 and connectable to the network node 1100 through an interface or port.

The antenna 1110, communication interface 1106, and/or the processing circuitry 1102 may be configured to perform any receiving operations and/or certain obtaining operations described herein as being performed by the network node. Any information, data and/or signals may be received from a UE, another network node and/or any other network equipment. Similarly, the antenna 1110, the communication interface 1106, and/or the processing circuitry 1102 may be configured to perform any transmitting operations described herein as being performed by the network node. Any information, data and/or signals may be transmitted to a UE, another network node and/or any other network equipment.

The power source 1108 provides power to the various components of network node 1100 in a form suitable for the respective components (e.g., at a voltage and current level needed for each respective component). The power source 1108 may further comprise, or be coupled to, power management circuitry to supply the components of the network node 1100 with power for performing the functionality described herein. For example, the network node 1100 may be connectable to an external power source (e.g., the power grid, an electricity outlet) via an input circuitry or interface such as an electrical cable, whereby the external power source supplies power to power circuitry of the power source 1108. As a further example, the power source 1108 may comprise a source of power in the form of a battery or battery pack which is connected to, or integrated in, power circuitry. The battery may provide backup power should the external power source fail.

Embodiments of the network node 1100 may include additional components beyond those shown in FIG. 11 for providing certain aspects of the network node's functionality, including any of the functionality described herein and/or any functionality necessary to support the subject matter described herein. For example, the network node 1100 may include user interface equipment to allow input of information into the network node 1100 and to allow output of information from the network node 1100. This may allow a user to perform diagnostic, maintenance, repair, and other administrative functions for the network node 1100.

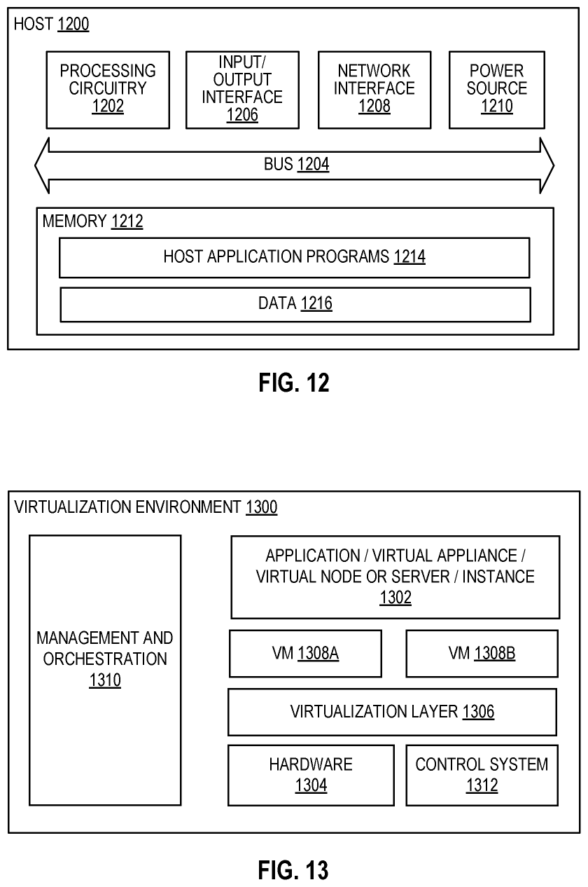

FIG. 12 is a block diagram of a host 1200, which may be an embodiment of the host 916 of FIG. 9, in accordance with various aspects described herein. As used herein, the host 1200 may be or comprise various combinations hardware and/or software, including a standalone server, a blade server, a cloud-implemented server, a distributed server, a virtual machine, container, or processing resources in a server farm. The host 1200 may provide one or more services to one or more UEs.

The host 1200 includes processing circuitry 1202 that is operatively coupled via a bus 1204 to an input/output interface 1206, a network interface 1208, a power source 1210, and a memory 1212. Other components may be included in other embodiments. Features of these components may be substantially similar to those described with respect to the devices of previous figures, such as FIGS. 10 and 11, such that the descriptions thereof are generally applicable to the corresponding components of host 1200.

The memory 1212 may include one or more computer programs including one or more host application programs 1214 and data 1216, which may include user data, e.g., data generated by a UE for the host 1200 or data generated by the host 1200 for a UE. Embodiments of the host 1200 may utilize only a subset or all of the components shown. The host application programs 1214 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1214 may also provide for user authentication and licensing checks and may periodically report health, routes, and content availability to a central node, such as a device in or on the edge of a core network. Accordingly, the host 1200 may select and/or indicate a different host for over-the-top services for a UE. The host application programs 1214 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 13 is a block diagram illustrating a virtualization environment 1300 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1300 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1302 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 1304 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1306 (also referred to as hypervisors or virtual machine monitors (VMMs)), provide VMs 1308a and 1308b (one or more of which may be generally referred to as VMs 1308), and/or perform any of the functions, features and/or benefits described in relation with some embodiments described herein. The virtualization layer 1306 may present a virtual operating platform that appears like networking hardware to the VMs 1308.

The VMs 1308 comprise virtual processing, virtual memory, virtual networking or interface and virtual storage, and may be run by a corresponding virtualization layer 1306. Different embodiments of the instance of a virtual appliance 1302 may be implemented on one or more of VMs 1308, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1308 may be a software implementation of a physical machine that runs programs as if they were executing on a physical, non-virtualized machine. Each of the VMs 1308, and that part of hardware 1304 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1308 on top of the hardware 1304 and corresponds to the application 1302.

Hardware 1304 may be implemented in a standalone network node with generic or specific components. Hardware 1304 may implement some functions via virtualization. Alternatively, hardware 1304 may be part of a larger cluster of hardware (e.g. such as in a data center or CPE) where many hardware nodes work together and are managed via management and orchestration 1310, which, among others, oversees lifecycle management of applications 1302. In some embodiments, hardware 1304 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1312 which may alternatively be used for communication between hardware nodes and radio units.

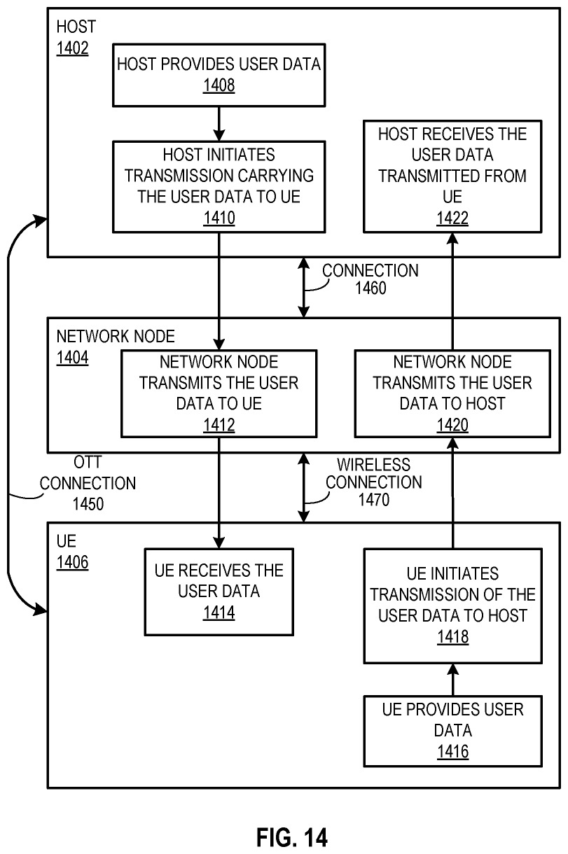

FIG. 14 shows a communication diagram of a host 1402 communicating via a network node 1404 with a UE 1406 over a partially wireless connection in accordance with some embodiments. Example implementations, in accordance with various embodiments, of the UE (such as a UE 912a of FIG. 9 and/or UE 1000 of FIG. 10), network node (such as network node 910a of FIG. 9 and/or network node 1100 of FIG. 11), and host (such as host 916 of FIG. 9 and/or host 1200 of FIG. 12) discussed in the preceding paragraphs will now be described with reference to FIG. 14.

Like host 1200, embodiments of host 1402 include hardware, such as a communication interface, processing circuitry, and memory. The host 1402 also includes software, which is stored in or accessible by the host 1402 and executable by the processing circuitry. The software includes a host application that may be operable to provide a service to a remote user, such as the UE 1406 connecting via an over-the-top (OTT) connection 1450 extending between the UE 1406 and host 1402. In providing the service to the remote user, a host application may provide user data which is transmitted using the OTT connection 1450.

The network node 1404 includes hardware enabling it to communicate with the host 1402 and UE 1406. The connection 1460 may be direct or pass through a core network (like core network 906 of FIG. 9) and/or one or more other intermediate networks, such as one or more public, private, or hosted networks. For example, an intermediate network may be a backbone network or the Internet.

The UE 1406 includes hardware and software, which is stored in or accessible by UE 1406 and executable by the UE's processing circuitry. The software includes a client application, such as a web browser or operator-specific “app” that may be operable to provide a service to a human or non-human user via UE 1406 with the support of the host 1402. In the host 1402, an executing host application may communicate with the executing client application via the OTT connection 1450 terminating at the UE 1406 and host 1402. In providing the service to the user, the UE's client application may receive request data from the host's host application and provide user data in response to the request data. The OTT connection 1450 may transfer both the request data and the user data. The UE's client application may interact with the user to generate the user data that it provides to the host application through the OTT connection 1450.

The OTT connection 1450 may extend via a connection 1460 between the host 1402 and the network node 1404 and via a wireless connection 1470 between the network node 1404 and the UE 1406 to provide the connection between the host 1402 and the UE 1406. The connection 1460 and wireless connection 1470, over which the OTT connection 1450 may be provided, have been drawn abstractly to illustrate the communication between the host 1402 and the UE 1406 via the network node 1404, without explicit reference to any intermediary devices and the precise routing of messages via these devices.

As an example of transmitting data via the OTT connection 1450, in step 1408, the host 1402 provides user data, which may be performed by executing a host application. In some embodiments, the user data is associated with a particular human user interacting with the UE 1406. In other embodiments, the user data is associated with a UE 1406 that shares data with the host 1402 without explicit human interaction. In step 1410, the host 1402 initiates a transmission carrying the user data towards the UE 1406. The host 1402 may initiate the transmission responsive to a request transmitted by the UE 1406. The request may be caused by human interaction with the UE 1406 or by operation of the client application executing on the UE 1406. The transmission may pass via the network node 1404, in accordance with the teachings of the embodiments described throughout this disclosure. Accordingly, in step 1412, the network node 1404 transmits to the UE 1406 the user data that was carried in the transmission that the host 1402 initiated, in accordance with the teachings of the embodiments described throughout this disclosure. In step 1414, the UE 1406 receives the user data carried in the transmission, which may be performed by a client application executed on the UE 1406 associated with the host application executed by the host 1402.

In some examples, the UE 1406 executes a client application which provides user data to the host 1402. The user data may be provided in reaction or response to the data received from the host 1402. Accordingly, in step 1416, the UE 1406 may provide user data, which may be performed by executing the client application. In providing the user data, the client application may further consider user input received from the user via an input/output interface of the UE 1406. Regardless of the specific manner in which the user data was provided, the UE 1406 initiates, in step 1418, transmission of the user data towards the host 1402 via the network node 1404. In step 1420, in accordance with the teachings of the embodiments described throughout this disclosure, the network node 1404 receives user data from the UE 1406 and initiates transmission of the received user data towards the host 1402. In step 1422, the host 1402 receives the user data carried in the transmission initiated by the UE 1406.

One or more of the various embodiments improve the performance of OTT services provided to the UE 1406 using the OTT connection 1450, in which the wireless connection 1470 forms the last segment. More precisely, the teachings of these embodiments may improve the throughput and/or availability of a UE in a communication network by avoiding potential overheating conditions.

In an example scenario, factory status information may be collected and analyzed by the host 1402. As another example, the host 1402 may process audio and video data which may have been retrieved from a UE for use in creating maps. As another example, the host 1402 may collect and analyze real-time data to assist in controlling vehicle congestion (e.g., controlling traffic lights). As another example, the host 1402 may store surveillance video uploaded by a UE. As another example, the host 1402 may store or control access to media content such as video, audio, VR or AR which it can broadcast, multicast or unicast to UEs. As other examples, the host 1402 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1450 between the host 1402 and UE 1406, in response to variations in the measurement results. The measurement procedure and/or the network functionality for reconfiguring the OTT connection may be implemented in software and hardware of the host 1402 and/or UE 1406. In some embodiments, sensors (not shown) may be deployed in or in association with other devices through which the OTT connection 1450 passes; the sensors may participate in the measurement procedure by supplying values of the monitored quantities exemplified above, or supplying values of other physical quantities from which software may compute or estimate the monitored quantities. The reconfiguring of the OTT connection 1450 may include message format, retransmission settings, preferred routing etc.; the reconfiguring need not directly alter the operation of the network node 1404. Such procedures and functionalities may be known and practiced in the art. In certain embodiments, measurements may involve proprietary UE signaling that facilitates measurements of throughput, propagation times, latency and the like, by the host 1402. The measurements may be implemented in that software causes messages to be transmitted, in particular empty or ‘dummy’ messages, using the OTT connection 1450 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

### REFERENCES

[1] 3GPP TS 38.331 v16.5.0

1. A method of operating a user equipment, UE, in a wireless communications system, comprising:
generating a prediction regarding a condition relating to overheating of the UE; and
reporting the prediction to a network node of the wireless communications system.

2. The method of claim 1, further comprising:
receiving a configuration from the network node for reporting the prediction regarding the condition relating to overheating, wherein the prediction regarding the condition relating to overheating is generated according to the configuration.

3. The method of claim 1, wherein the condition relating to overheating comprises a predicted temperature of the UE and/or a predicted duration of the overheating condition.

4. The method of claim 1, wherein the prediction regarding the condition relating to overheating is generated using a machine learning model.

5. The method of claim 1, wherein the prediction regarding the condition relating to overheating is generated based on a plurality of features relating to wireless communications by the UE.

6. The method of claim 5, wherein the plurality of features comprise at least one of a bandwidth allocated to the UE, a number of configured multiple input multiple output, MIMO, layers of the UE, a number of carriers assigned to the UE, a throughput of communications with the UE, a buffer size in the UE, and sensor information collected by the UE.

7. The method of claim 1, wherein the prediction regarding the condition relating to overheating comprises a time window within which the prediction regarding the condition relating to overheating is expected to occur.

8. The method of claim 1, wherein the prediction regarding the condition relating to overheating comprises a confidence level associated with the prediction.

9. The method of claim 8, wherein the confidence level comprises a percentage likelihood of the condition relating to overheating occurring within a predetermined time period.

10. The method of claim 9, wherein the predetermined time period is configured by the network node.

11. The method of claim 9, wherein the predetermined time period is transmitted to the network node in a report that includes the prediction.

12. The method of claim 8, wherein the prediction is only reported to the network node if the confidence level is greater than a threshold level.

13. The method of claim 1, wherein the prediction regarding the condition relating to overheating comprises a prediction of an onset of an overheating condition or a prediction of an end of an overheating condition.

14. The method of claim 1, further comprising transmitting a recommended action for the network node to take to address the predicted condition relating to overheating.

15. The method of claim 14, wherein the recommended action comprises at least one of reducing a bandwidth allocated to the UE, reducing a number of configured MIMO layers of the UE, reducing a number of carriers assigned to the UE, and reducing a throughput of communications with the UE.

16. The method of claim 14, further comprising generating and transmitting to the network node an estimate of an amount of time overheating condition is expected to continue after the recommended action is taken.

17. The method of claim 1, wherein the prediction regarding the condition relating to overheating comprises a prediction of an end of an overheating condition, and wherein the prediction is included in a report that also includes a report of the onset of the overheating condition.

18. The method of claim 1, further comprising:
generating a prediction of an expected time when the overheating condition will require network intervention; and
transmitting the prediction of the expected time when the overheating condition will require network intervention to the network node.

19. The method of claim 1, further comprising:
determining the status of a prohibit timer before reporting the prediction to the network node;
wherein the prediction is only reported to the network node after the prohibit timer has expired.

20. The method of claim 1, further comprising:
receiving a conditional configuration from the network node; and
applying the conditional configuration in response to one of the following events:
a predetermined overheating condition is reached,
a predicted overheating condition is reported, and
a predetermined time period has elapsed following the time that the predetermined overheating condition is reached or that the predicted overheating condition was reported.

21.-40. (canceled)
